(19) United States
(12) Patent Application Publication
(10) Pub. No.: US 2026/0136233 A1
(43) Pub. Date: May 14, 2026

(54) IMPROVEMENTS IN AND RELATING TO QUALITY OF SERVICE, QOS, IN A TELECOMMUNICATION NETWORK

(71) Applicant: Samsung Electronics Co., Ltd., Suwon-si, Gyeonggi-do (KR)

(72) Inventor: Donggun KIM, Suwon-si (KR)

(21) Appl. No.: 19/119,258

(22) PCT Filed: Dec. 20, 2023
(86) PCT No.: PCT/KR2023/021124

§ 371 Date: Apr. 8, 2025

(30) Foreign Application Priority Data
Dec. 23, 2022 (GB) 2219705.7
Nov. 23, 2023 (GB) 2317920.3

(51) Int. Cl. H04W 28/02; H04W 12/03; H04W 12/106

(52) U.S. Cl. CPC H04W 28/0263; H04W 12/03; H04W 12/106; H04W 28/0268

(57) ABSTRACT

The present disclosure relates to a 5G communication system or a 6G communication system for supporting higher data rates beyond a 4G communication system such as long term evolution (LTE). A method performed by a user equipment (UE) for Quality of Service (QoS) differentiation for data in a wireless communication system, the method comprising the steps of: receiving a message for radio resource control (RRC) reconfiguration including configuration information associated with a Service Data Adaptation Protocol (SDAP) header, QoS flow mapping, and sub QoS flow; performing QoS flow mapping to a Data Radio Bearer (DRB) based on a QoS flow ID and a sub QoS flow ID in the configuration information; transmitting a SDAP data protocol data unit (PDU) with QoS Flow ID (QFI) and a field indicating a sub QoS flow ID to one or more lower layers; performing integrity protection for the SDAP data including the field, and ciphering for the SDAP data except the SDAP header including the field; and transmitting the SDAP data after the integrity protection and the ciphering to one or more lower layers.

### TECHNICAL FIELD

The present invention relates to enhancement of user experience, as measure by Quality of Service, QoS. It finds particular but not exclusive use in Fifth Generation, 5G, or New Radio, NR, systems.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems.

In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

For NR sidelink communication, reflective PC5 QoS flow to SL-DRB mapping is not supported.

When a QoS Flow is associated with QoS requirements, the QoS flow can support a service to meet the requirements. Logically speaking, the QoS flow is a path via which the data for the service with the same requirement is transported.

QoS remapping was previously introduced to consider the change of QoS flow or QoS requirement. However, it cannot reflect the dynamic change of QoS requirement (high data rate, low latency, characteristics, priority, etc) among the data within the same QoS flow. Note that the QoS requirement for a QoS flow may vary over time.

For example, the data within the same QoS flow could be a multi-modal data (e.g. audio, video, and haptic data related to a specific time) or Artificial Intelligence/Machine learning, AI/ML, data (e.g. normal data or training data) or a data burst.

The only way to achieve this would be to perform QoS reconfiguration for the service and remapping, dynamically, which would result in a heavy signaling overhead and unnecessary latency. This is undesirable when there is a general desire to minimise the signaling overhead and reduce latency.

It is therefore an aim of embodiments of the invention to address and overcome problems in the prior art, whether mentioned herein or not.

### Solution to Problem

According to the present invention there is provided an apparatus and method as set forth in the appended claims. Other features of the invention will be apparent from the dependent claims, and the description which follows.

According to a first aspect of the present invention, there is provided a method of performing Quality of Service, QoS, differentiation for data in a wireless telecommunication system, the method comprising the steps of: receiving a RRCReconfiguration message including information related to a configuration of a Service Data Adaptation Protocol, SDAP, header, QoS flow mapping, and sub QoS flow; performing QoS flow mapping to a Data Radio Bearer, DRB, based on a QoS flow ID and a sub QoS flow Identity; submitting a SDAP data PDU with QoS Flow ID (QFI) and a field indicating a sub QoS flow identity to one or more lower layers; performing integrity protection for the data including the field, and ciphering for the data except the SDAP header including the field; submitting the resulting data to one or more lower layers.

In an embodiment, QoS differentiation results in different processing of data so differentiated.

In an embodiment, the integrity protection and ciphering is performed at a PDCP entity, positioned below the SDAP entity.

In an embodiment, after integrity protection and ciphering is performed, the resultant data is transmitted to a lower layer for transmission.

In an embodiment, header compression is not applied to the SDAP header.

In an embodiment, if the QoS flow to DRB mapping is not stored or not configured for the SDAP entity, then reflective mapping is applied.

According to a second aspect of the present invention, there is provided an apparatus arranged to perform the method of the first aspect.

Although a few preferred embodiments of the present invention have been shown and described, it will be appreciated by those skilled in the art that various changes and modifications might be made without departing from the scope of the invention, as defined in the appended claims.

### Advantageous Effects of Invention

Embodiments of the present disclosure provides methods and apparatus for QoS differentiation to support dynamic change of QoS requirement.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 show summary Protocol Stacks known in the prior art;

FIG. 2 shows a representation of data/QoS flows in a New radio system, known in the prior art;

FIG. 3 shows a representation of the interface between the User Equipment, UE, and the User Plane Function, UPF;

FIG. 4 shows a representation of certain connections/interface between a UE and a Data network, known in the prior art;

FIG. 5 shows how the SDAP sublayer relates QoS flows to radio bearers, known in the prior art;

FIG. 6 shows how an SDAP entity receives/delivers SDAP Service Data Units, SDUs, from/to upper layers and submits/receives SDAP data PDUs to/from its peer SDAP entity via lower layers, known in the prior art;

FIG. 7 shows an updated protocol stack and header according to an embodiment of the present invention;

FIG. 8 shows an updated header according to an embodiment of the present invention;

FIG. 9 shows an updated protocol stack according to an embodiment of the present invention; and

FIG. 10 shows an updated header according to an embodiment of the present invention.

### MODE FOR THE INVENTION

Fifth Generation, 5G, telecommunication networks make use of a Quality of Service, QoS, model, based on QoS Flows and supports both QoS Flows that require a guaranteed flow bit rate (GBR QoS Flows) and QoS Flows that do not require a guaranteed flow bit rate (non-GBR QoS Flows). At Non-Access Stratum, NAS, level, the QoS flow is thus the finest granularity of QoS differentiation in a Protocol Data Unit, PDU, session. A QoS flow is identified within a PDU session by a QoS Flow ID (QFI) carried in an encapsulation header over The NG user plane interface (NG-U), which is defined between the NG-Radio Access Node, RAN, and the User plane Function, UPF.

The gNB includes Central Unit and Distributed Unit (CU-DU) split architecture where gNB Central Unit (gNB-CU) is a logical node hosting RRC, SDAP (Service Data Adaptation Protocol) and PDCP protocols of the gNB or RRC and PDCP protocols of the gNB that controls the operation of one or more gNB-DUs, and gNB Distributed Unit (gNB-DU) is a logical node hosting RLC, MAC and PHY (Physical) layers of the gNB, and its operation is partly controlled by gNB-CU. The gNB-CU terminates the F1 interface connected with the gNB-DU. One gNB-DU supports one or multiple cells. One cell is supported by only one gNB-DU. The gNB-DU terminates the F1 interface connected with the gNB-CU. For DC operation, the Master gNB-DU designates the gNB-DU of an gNB or a gNB acting as master node, and the Secondary gNB-DU designates the gNB-DU of an gNB or a gNB acting as secondary node.

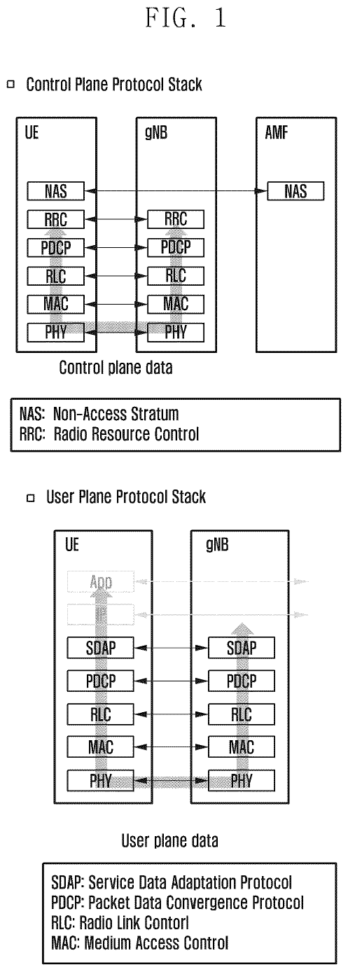

FIG. 1 shows a general representation of the protocol stacks in the Control Plane and User Plane. These will be referred to in this application.

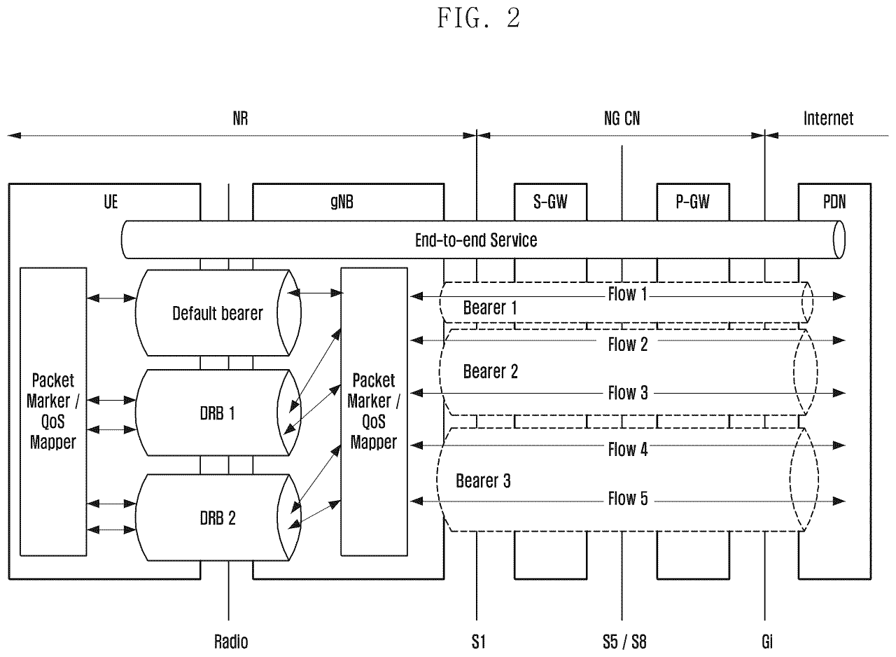

FIG. 2 shows a representation of data/QoS flows in a New Radio system, interface to a Core Network, NG CN, and the Internet. It illustrates the how Data Radio Bearers, DRB, map to QoS flows.

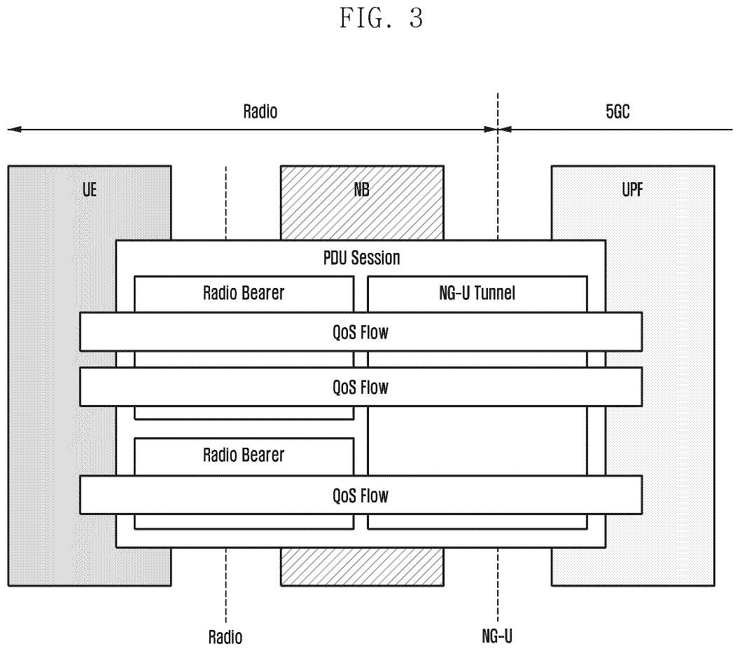

FIG. 3 shows a representation of the interface between the User Equipment, UE, and the UPF and how a PDU session may have several radio bearers, each of which may comprise one or more QoS flows.

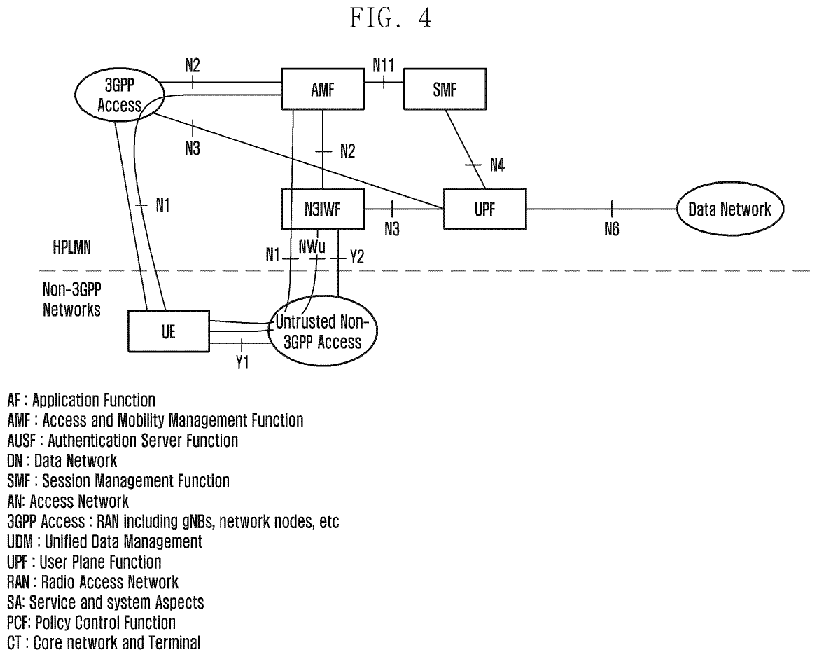

FIG. 4 show a representation of certain connections/interface between a UE and a Data network. It shows the names of certain interfaces between various entities in the network. Some of these will be referred to in this application.

The UE may connect via a Home network, HPLMN, via 3GPP access or via untrusted non-3GPP Access (e.g. WiFi).

As mentioned, The QoS Flow is the finest granularity of QoS differentiation in the PDU Session. A QoS Flow ID (QFI) is used to identify a QoS Flow in the 5G System. User Plane, UP, traffic with the same QFI within a PDU Session receives the same traffic forwarding treatment (e.g. scheduling, admission threshold). The QFI is carried in an encapsulation header on the N3 interface (and N9 also) i.e. without any changes to the e2e packet header. N3 is a interface between the (R)AN and the UPF while N9 (not shown in FIG. 4) is an interface between two UPFs. QFI is used for all PDU Session Types. The QFI is unique within a PDU Session. The QFI may be dynamically assigned or may be equal to the 5G QoS Identifier, 5QI.

Within the 5G system, 5GS, a QoS Flow is controlled by the Session Management Function, SMF, and may be preconfigured, or established via the PDU Session Establishment procedure, or the PDU Session Modification procedure.

Any QoS Flow is characterised by:
a QoS profile provided by the SMF to the Access network, AN, via the Access and Mobility Management Function, AMF, over the N2 reference point or preconfigured in the AN;
one or more QoS rule(s) and, optionally, QoS Flow level QoS parameters associated with these QoS rule(s), which can be provided by the SMF to the UE via the AMF over the N1 reference point and/or derived by the UE by applying Reflective QoS control; and
one or more UL and Downlink, DL, Packet Detection Rule(s), PDR(s), provided by the SMF to the UPF.

Within the 5GS, a QoS Flow associated with the default QoS rule is required to be established for a PDU Session and remains established throughout the lifetime of the PDU Session. This QoS Flow should be a Non-GBR QoS Flow.

A QoS Flow is associated with QoS requirements as specified by QoS parameters and QoS characteristics.

Note that the above QoS Flow provides the UE with connectivity throughout the lifetime of the PDU Session. Possible interworking with Evolved Packet System, EPS, motivates the recommendation for this QoS Flow to be of type “Non-GBR”.

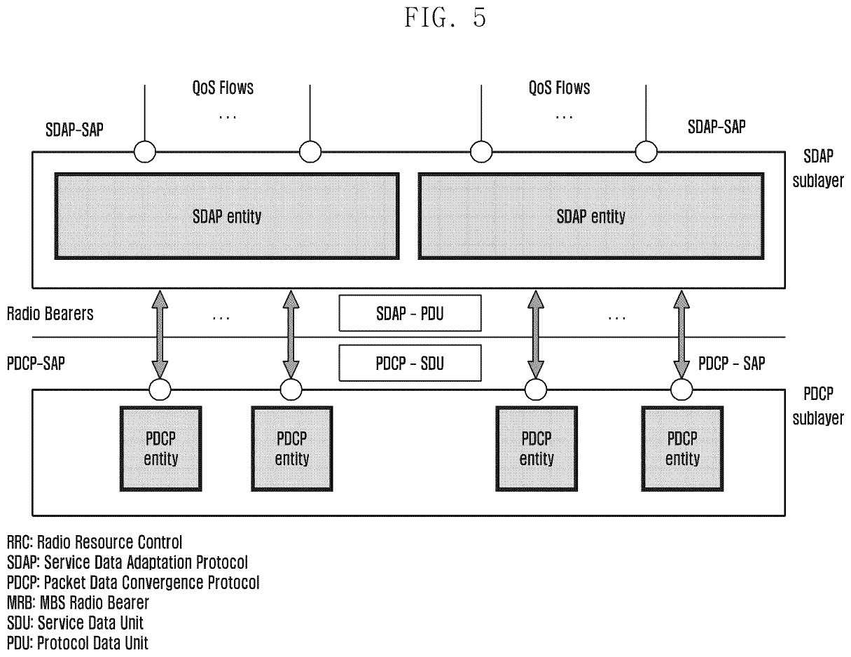

A further issue relates to QoS handling in the Service Dara Adaptation protocol, SDAP. The SDAP sublayer is configured for DRBs by the radio Resource Control, RRC, layer. The SDAP sublayer maps QoS flows to DRBs. One or more QoS flows may be mapped onto one DRB. One QoS flow is mapped onto only one DRB at a time in the UL. This is illustrated in FIG. 5 which shows how the SDAP sublayer relates QoS flows to radio bearers.

The SDAP sublayer is configured for Mobile Broadband System, MBS, Radio Bearers, MRBs, by RRC. The SDAP sublayer maps MBS QoS flows to MRBs. One or more MBS QoS flows may be mapped onto one MRB.

In NR sidelink, SL, communications, the SDAP sublayer maps PC5 QoS flows to SL-DRBs. One or more PC5 QoS flows may be mapped onto one SL-DRB. One PC5 QoS flow is mapped onto only one SL-DRB at a time in the NR sidelink for transmission.

The SDAP entities are located in the SDAP sublayer. Several SDAP entities may be defined for a UE. There is an SDAP entity configured for each individual PDU session or MBS session for the NR Uu interface, which is the logical interface between the UE and the base station. For NR sidelink, SDAP entity is configured per Destination Layer-2 ID and cast type in the UE.

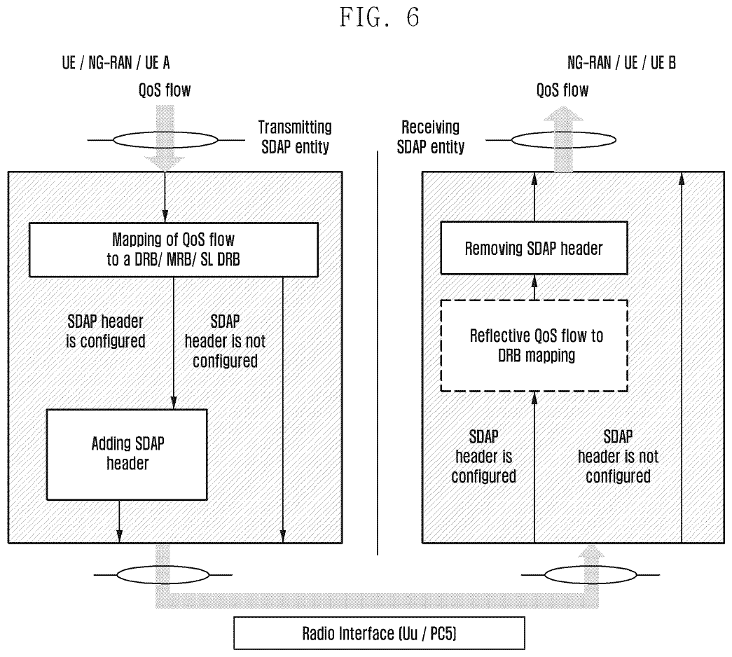

As shown in FIG. 6, an SDAP entity receives/delivers SDAP Service Data Units, SDUs, from/to upper layers and submits/receives SDAP data PDUs to/from its peer SDAP entity via lower layers. At the transmitting side, when an SDAP entity receives an SDAP SDU from upper layers, it constructs the corresponding SDAP data PDU and submits it to lower layers (i.e. PDCP layer). At the receiving side, when an SDAP entity receives an SDAP data PDU from lower layers, it retrieves the corresponding SDAP SDU and delivers it to upper layers.

Reflective QoS flow to DRB mapping is performed at the UE, if DL SDAP header is configured.

Reflective QoS flow to MRB mapping is not supported. There is no SDAP header for MRB.

For NR sidelink communication, reflective PC5 QoS flow to SL-DRB mapping is not supported.

When a QoS Flow is associated with QoS requirements, the QoS flow can support a service to meet the requirements. Logically speaking, the QoS flow is a path via which the data for the service with the same requirement is transported.

QoS remapping was previously introduced to consider the change of QoS flow or QoS requirement. However, it cannot reflect the dynamic change of QoS requirement (high data rate, low latency, characteristics, priority, etc) among the data within the same QoS flow. Note that the QoS requirement for a QoS flow may vary over time. For example, the data within the same QoS flow could be a multi-modal data (e.g. audio, video, and haptic data related to a specific time) or Artificial Intelligence/Machine learning, AI/ML, data (e.g. normal data or training data) or a data burst.

The only way to achieve this would be to perform QoS reconfiguration for the service and remapping, dynamically, which would result in a heavy signaling overhead and unnecessary latency. This is undesirable when there is a general desire to minimise the signaling overhead and reduce latency.

It is therefore an aim of embodiments of the invention to address and overcome problems in the prior art, whether mentioned herein or not.

Embodiments of the present invention provide dynamic QoS differentiation and data processing thereof in the RAN.

To support the dynamic change of QoS requirement among the data within the same QoS flow, several techniques are presented below relating to dynamic QoS differentiation in Non Access Stratum, NAS, and Access Stratum, AS, and how to process the data based on it.

Embodiments can also enhance QoE (Quality of Experience) as well as QoS (Quality of Service) because it enables different data processing for the data within the same QoS flow.

A new indicator (or identifier), e.g. sub-QoS flow ID, can be introduced in the SDAP header or in a new entity's header of SDAP sublayer or in a new layer's header for RAN data processing in AS (Access Stratum). Sub QoS flow can be defined as the new indicator (i.e. sub QoS flow Id). The value of sub QoS flow identity (or field) is unique within the same QoS flow ID. In other words, different sub QoS flow IDs with the same QoS flow ID have different values to tell them apart.

A new indicator (or identifier), e.g. sub-QoS flow ID, can be introduced in an encapsulation header on N3 (and N9) (for N3 GTP-U tunnel or N9 GTP-U tunnel between UPF (or NG RAN) and the NG RAN (gNB)). Sub QoS flow can be defined as the new indicator (i.e. sub QoS flow Id).

To support this feature, an efficient header design and associated configuration is provided.

In the new layer or SDAP layer, the new procedures are provided based on a new indicator or identifier. Further, to support this feature during handover, further new procedures are provided.

There are several options for a new header design presented herein.

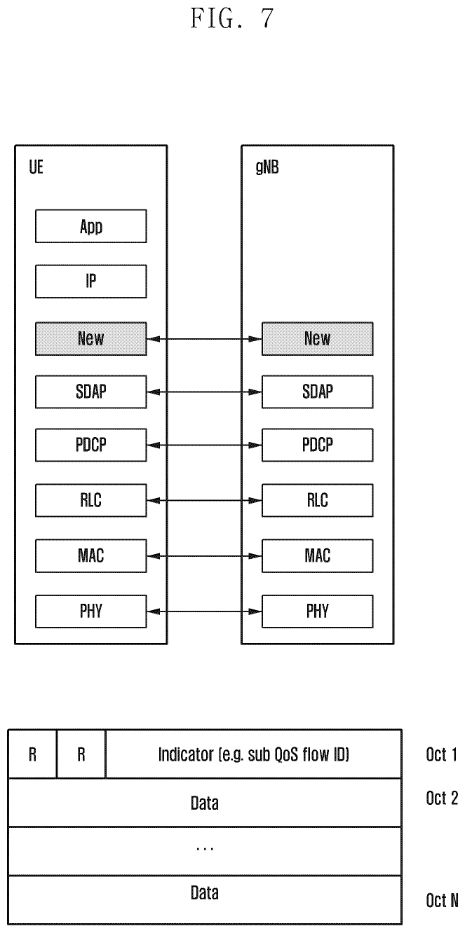

In a first option, a new layer (or entity) immediately above the SDAP layer (or entity) is provided and labelled “New” in FIG. 7. In another embodiment, the new entity can be introduced and provided above a SDAP entity in SDAP sublayer.

The new layer can handle a newly defined indicator (or identifier), e.g. sub-QoS flow ID, to support dynamic QoS differentiation. The new indicator can include/indicate multiple fields (or indicators), e.g. whether to be ciphered (or deciphered) (for the data) or not, whether to be integrity protected (or integrity verified) (for the data) or not, priority, high data rate, low latency, characteristics, or type of data.

The transmitting entity of the new layer generates a certain size of header including the newly defined indicator, attaches it to the front of the SDU, and submits it to lower layers (e.g. SDAP entity).

The receiving entity of the new layer reads the new header, removes it, and delivers it to the upper layer when it receives a PDU from lower layers.

The new header including a newly defined indicator (or identifier), e.g. sub-QoS flow ID can have a fixed size (e.g. 1 byte) for downlink and uplink.

The new layer (or entity) may be called a certain, descriptive, name, such as RAP (Radio Analytics Protocol). The new header can be called a certain name, e.g. RAP header

The new indicator can be introduced in an encapsulation header on N3 (or N9) as well, i.e. the gNB can extract the new indicator from the N3 (or N9) header, and set the new indicator in the new header for downlink while the gNB can extract the new indicator from the new header, and set the new indicator in the N3(or N9) header for uplink, which can allow the RAN (the gNB) to perform dynamic QoS differentiation.

The presence of the new or SDAP header is configurable for DL (Downlink) or UL (Uplink) by RRC (i.e. by RRCReconfiguration message). In another embodiment, the presence of the new header can be configured for DL (or UL) only if the presence of the SDAP header is configured for DL (or UL) because the QoS flow ID (QFI) should be indicated in the SDAP header to perform dynamic QoS differentiation, based on the new indicator included in the new header within the same QFI (QoS flow ID).

Based on the RRC (Radio Resource Control) configuration, the SDAP entity learns of the presence of the new header and the new indicator, and the SDAP entity can consider QFI and the new indicator when it performs QoS flow to DRB mapping. i.e. the SDAP entity performs QoS flow to DRB mapping based on QFI in SDAP header and the new header.

One or more QoS flows may be mapped onto one DRB. One QoS flow is mapped onto only one DRB at a time in the UL (or DL).

In another embodiment, one or more QoS flows may be mapped onto one DRB. One QoS flow is mapped onto only one DRB at a time in the UL (or DL) except in the case that the new header (or the new indicator in the new header) is included. One QoS flow with different indicator (or identifier) can be mapped onto different DRBs (or sub-DRBs) at a time in the UL (or DL). The sub DRB means that the smaller unit of DRB performs different data processing based on the new indicator for the data of the same DRB.

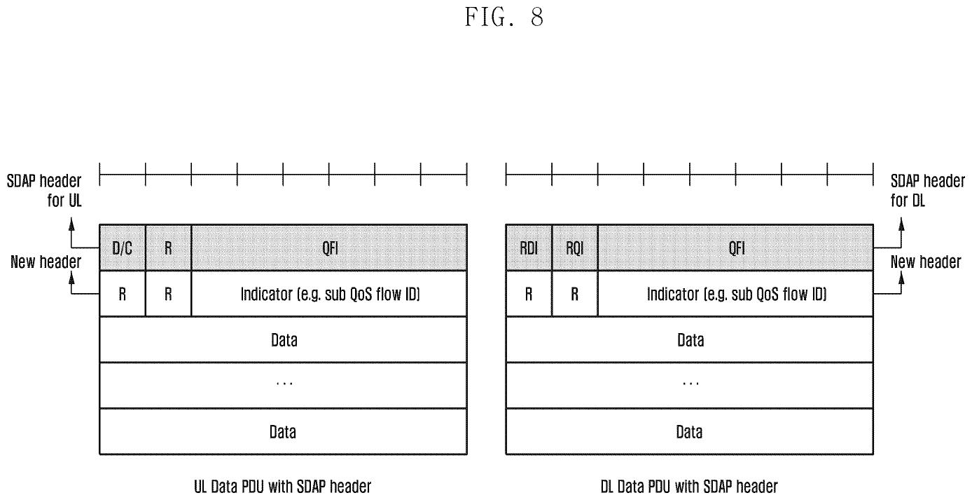

FIG. 8 summarises the above. It shows UL and DL PDU with SDAP header and shows the new header and the associated indicator sub QoS flow ID.

The header decompression is a peer function of the header compression, i.e. if the header compression is applied at the transmitting side, the header decompression should be applied at the receiving side. Similarly, the ciphering (or integrity protection) is a peer function of the deciphering (or integrity verification), i.e. if the ciphering (or integrity protection) is applied at the transmitting side, the deciphering (or integrity verification) should be applied at the receiving side. The PDCP entity below SDAP entity may perform header compression/decompression, ciphering/deciphering, and integrity protection/verification for the data. After this process, it can submit the data to the lower layers (e.g. RLC layer or MAC layer) for transmission.

To ease the implementation, the new header and the new indicator field can be considered as a part of the data, i.e. header compression/decompression are not applied to the new header, but ciphered (or deciphered) the ciphering (or deciphering) or the integrity protection (or the integrity verification) at the transmitting side (or at the receiving side) can be applied to the new header as follows.

The header compression using Robust Header Compression, ROHC, (or Ethernet Header Compression, EHC) or the uplink data compression (UDC) is not applicable to the SDAP header, the new header, and the SDAP Control PDU if included in the PDCP SDU. The header decompression using ROHC (or EHC) or the uplink data decompression (UDC) is not applicable to the SDAP header, the new header, and the SDAP Control PDU if included in the PDCP Data PDU.

The data unit that is ciphered (or deciphered) is the MAC-I and the data part of the PDCP Data PDU except the SDAP header (or PDCP header) and the SDAP Control PDU if included in the PDCP SDU where the data unit includes the new header (or EHC header or UDC header or ROHC header). The data unit that is integrity protected (or integrity verified) is the PDU header (e.g. PDCP header or SDAP header) and the data part (i.e. including the new header (or EHC header or UDC header or ROHC header)) of the PDU before ciphering.

In another embodiment, the Distributed Unit, DU, can utilize the information of the new header including the new indicator for scheduling as well as easy implementation in the case of the Centralised Unit-Distributed Unit, CU-DU, split architecture of gNB.

As such, the new header including the new indicator field is not ciphered (or deciphered), i.e. header compression/decompression or the uplink data compression (UDC) are not applied to the new header; the new header is not ciphered (or deciphered) but the integrity protection is applied to the new header to let the DU read/utilize the information as follows.

The header compression using ROHC (or EHC) or the uplink data compression (UDC) is not applicable to the SDAP header, the new header, and the SDAP Control PDU if included in the PDCP SDU. The header decompression using ROHC (or EHC) or the uplink data decompression (UDC) is not applicable to the SDAP header, the new header, and the SDAP Control PDU if included in the PDCP Data PDU. The data unit that is ciphered (or deciphered) is the MAC-I and the data part of the PDCP Data PDU except the SDAP header (or PDCP header), the new header and the SDAP Control PDU if included in the PDCP SDU where the data unit includes EHC header or UDC header or ROHC header. The data unit that is integrity protected (or integrity verified) is the PDU header (e.g. PDCP header or SDAP header) and the data part (i.e. including the new header) of the PDU before ciphering

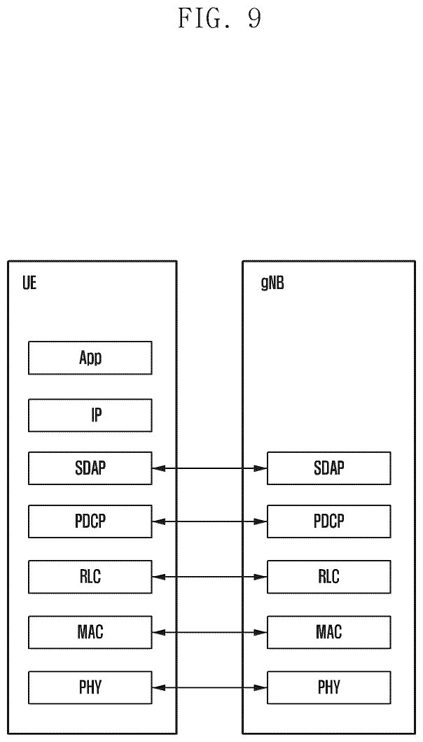

In a second option, a new indicator in SDAP header is provided as shown in FIG. 9.

The SDAP layer is able to handle a newly defined indicator (or identifier), e.g. sub-QoS flow ID, to support dynamic QoS differentiation. The new indicator can include/indicate multiple fields (or indicators), e.g. whether to be ciphered (or deciphered) (for the data) or not, whether to be integrity protected (or integrity verified) (for the data) or not, priority, high data rate, low latency, characteristics, or type of data.

The SDAP entity generates an SDAP header including the newly defined indicator, attaches it to the front of the SDU, and submits it to lower layers (e.g. PDCP entity).

The SDAP reads the new header, removes it, and delivers it to the upper layer when it receives PDU from lower layers.

The SDAP header including a newly defined indicator (or identifier), e.g. sub-QoS flow ID can have a fixed size (e.g. 1 byte without the newly defined indicator or 2 byte with the newly defined indicator) for downlink and uplink.

One or more QoS flows may be mapped onto one DRB. One QoS flow is mapped onto only one DRB at a time in the UL (or DL). In another embodiment, one or more QoS flows may be mapped onto one DRB. One QoS flow is mapped onto only one DRB at a time in the UL (or DL) except the case that the new indicator in SDAP header is included. One QoS flow with different indicator (or identifier) can be mapped onto different DRBs (or sub-DRBs) at a time in the UL (or DL). The sub DRB means the smaller unit of DRB performing different data processing based on the new indicator for the data of the same DRB.

The new indicator can be introduced in an encapsulation header on N3 (or N9) as well, i.e. the gNB can extract the new indicator from the N3 (or N9) header, and set the new indicator in SDAP header for downlink while the gNB can extract the new indicator from the SDAP header, and set the new indicator in the N3(or N9) header for uplink, which can allow RAN (the gNB) performs dynamic QoS differentiation.

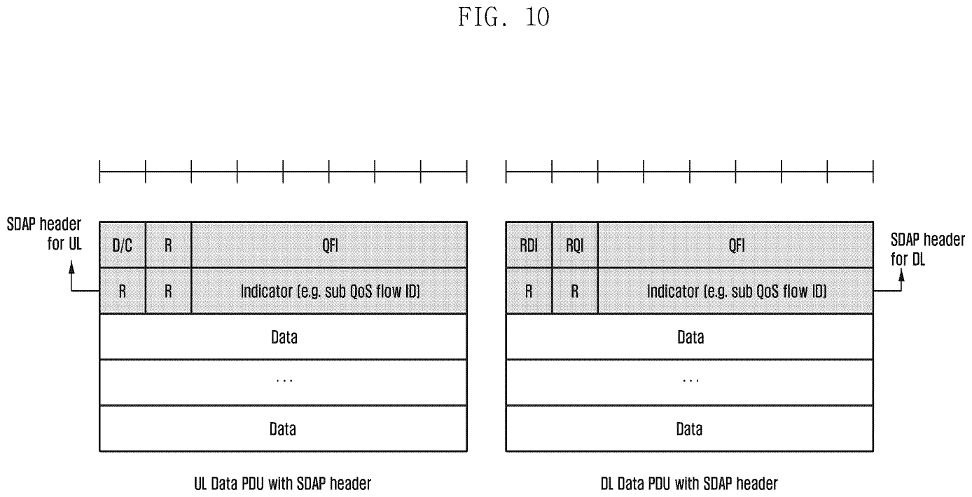

FIG. 10 shows the new SDAP header in the context of a UL Data PDU with SDAP header and a DL Data PDU with SDAP header.

FIG. 10 shows the introduction of a new indicator in the SDAP header as shown in the figure.

The presence of the SDAP header is configurable for DL (Downlink) or UL (Uplink) by RRC. The presence of a new indicator (or the size of SDAP header) is configurable for DL or UL by RRC.

In another embodiment, the presence of a new indicator (or the size of SDAP header) can be configured for DL (or UL) only if the presence of the SDAP header is configured for DL (or UL) because the QoS flow ID (QFI) should be indicated in SDAP header to perform dynamic QoS differentiation based on the new indicator within the same QFI (QoS flow ID).

Based on the RRC configuration, the SDAP entity gets to know the presence of the new indicator and the size of SDAP header, and the SDAP entity can consider QFI and the new indicator when it performs QoS flow to DRB mapping. i.e. the SDAP entity performs QoS flow to DRB mapping based on QFI in SDAP header and the new indicator.

In another embodiment, the presence of the new indicator can be indicated by the Reserved field (R field) in SDAP header (i.e. a newly defined field) or the newly defined value of QFI in SDAP header, i.e. an indication (or newly defined value of QFI) of SDAP header can indicate whether the new indicator is present or not in SDAP header.

To ease the implementation of the new header, the new indicator field in the SDAP header can be considered as a part of data, i.e. header compression/decompression are not applied to the SDAP header, but the new indicator in SDAP header is ciphered (or deciphered) but integrity protected (or integrity verified) as follows.

The header compression using ROHC (or EHC) or the uplink data compression (UDC) is not applicable to the SDAP header (or the new indicator in SDAP header), and the SDAP Control PDU if included in the PDCP SDU. The header decompression using ROHC (or EHC) or the uplink data decompression (UDC) is not applicable to the SDAP header (or the new indicator in SDAP header), and the SDAP Control PDU if included in the PDCP Data PDU. The data unit that is ciphered (or deciphered) is the MAC-I and the data part of the PDCP Data PDU except the SDAP header other than the new indicator in SDAP header, and the SDAP Control PDU if included in the PDCP SDU where the data unit includes EHC header or UDC header or ROHC header. (i.e. the new indicator in SDAP header is ciphered (or deciphered)). The data unit that is integrity protected (or integrity verified) is the PDU header (e.g. PDCP header or SDAP header) and the data part of the PDU including the new indicator in SDAP header before ciphering.

In another embodiment, the DU can utilize the information of the new indicator for scheduling as well as easy implementation in the case of the CU-DU split architecture of gNB. So the SDAP header including the new indicator field is not ciphered (or deciphered), i.e. header compression/decompression are not applied to the new indicator, the new indicator is not ciphered (or deciphered) but the integrity protection is applied to the new indicator to let the DU read/utilize the information and prevent a security attack by using integrity protection as follows.

The header compression using ROHC (or EHC) or the uplink data compression (UDC) is not applicable to the SDAP header (or the new indicator in SDAP header), and the SDAP Control PDU if included in the PDCP SDU. The header decompression using ROHC (or EHC) or the uplink data decompression (UDC) is not applicable to the SDAP header (including the new indicator in SDAP header), and the SDAP Control PDU if included in the PDCP Data PDU. The data unit that is ciphered (or deciphered) is the MAC-I and the data part of the PDCP Data PDU except the SDAP header (including the new indicator in SDAP header), and the SDAP Control PDU if included in the PDCP SDU where the data unit includes EHC header or UDC header or ROHC header (i.e. the new indicator in SDAP header is not ciphered (or deciphered)). The data unit that is integrity protected (or integrity verified) is the PDU header (e.g. PDCP header or SDAP header) and the data part of the PDU including the new indicator before ciphering.

In addition, an End marker Control PDU (can be called as SDAP control PDU) can be defined, which can include D/C field (Data PDU or Control PDU indication field), Reserved field, QFI field, or a new indicator field. Reserved field (i.e. newly defined field) or the pre-defined (newly defined) value of QFI field can indicate whether the new indicator is present or not. End-Marker control PDU is used by the new entity at UE to indicate that it stops the mapping of the SDU of the QoS flow (or sub QoS flow) indicated by the QFI/the new indicator to the DRB (or sub DRB) on which the End-Marker control PDU (i.e. SDAP control PDU) is transmitted. The new indicator (i.e. sub-QoS flow ID) can be included in a new SDAP control PDU (e.g. with the size of 2 byte) to be used at UE to indicate that it stops the mapping of the SDU of the QoS flow (or sub QoS flow) indicated by the QFI/the new indicator to the DRB (or sub DRB) on which the End-Marker control PDU is transmitted.

When RRC configures a QoS flow (or a sub QoS flow) to DRB (or sub DRB) mapping rule for a QoS flow (or sub QoS flow or QoS flow with the new indicator), the SDAP entity shall act as follows. Note that the QoS flow (or a sub QoS flow) to DRB (or sub DRB) mapping rule (or information) configured for SDAP entity indicates the list of QFI (QoS Flow ID)s of UL QoS flows of the PDU session to be additionally mapped to this DRB. A QFI value can be included at most once in all configured instances of SDAP configuration with the same value of PDU-Session:
a) if the SDAP entity has already been established and there is no stored QoS flow (or no sub QoS flow or no QoS flow with the new indicator) to DRB (or sub DRB) mapping rule for the QoS flow (or a sub QoS flow) and a default DRB is configured:
   i) construct an end-marker control PDU for the QoS flow (or sub QoS flow or QoS flow with the new indicator);
   ii) map the end-marker control PDU to the default DRB;
   iii) submit the end-marker control PDU to the lower layers.
b) if the stored UL QoS flow (or sub QoS flow or QoS flow with the new indicator) to DRB (or sub DRB) mapping rule is different from the configured QoS flow (or sub QoS flow) to DRB (or sub DRB)mapping rule for the QoS flow and the DRB (or sub DRB) according to the stored QoS flow (or sub QoS flow) to DRB (or sub DRB) mapping rule is configured by RRC with the presence of UL SDAP header:
   i) construct an end-marker control PDU for the QoS flow (or sub QoS flow or QoS flow with the new indicator);
   ii) map the end-marker control PDU to the DRB (or sub DRB) according to the stored QoS flow to DRB mapping rule;
   iii) submit the end-marker control PDU to the lower layers (i.e. PDCP layer).
c) store the configured UL QoS flow to DRB (or sub DRB) mapping rule for the QoS flow.

When RRC releases an UL QoS flow (or sub QoS flow) to DRB mapping rule for a QoS flow (or sub QoS flow), the SDAP entity shall remove the UL QoS flow (or sub QoS flow) to DRB mapping rule for the QoS flow.

If the QoS flow (or sub QoS flow) to DRB (or sub DRB) mapping is not stored or not configured for a SDAP entity, a reflective mapping is applied as follows: For each received DL SDAP data PDU with DRB Mapping Indication (RDI) set to 1, the SDAP entity shall:
a) process the QFI field in the SDAP header and determine the QoS flow (or sub QoS flow or QoS flow with the new indicator);
b) if there is no stored QoS flow (or sub QoS flow) to DRB (or sub DRB) mapping rule for the QoS flow (or sub QoS flow) and a default DRB is configured:
   i) construct an end-marker control PDU for the QoS flow (or sub QoS flow or QoS flow with the new indicator) ;
   ii) map the end-marker control PDU to the default DRB;
   iii) submit the end-marker control PDU to the lower layers (i.e. PDCP layer);
c) if the stored QoS flow (or sub QoS flow) to DRB (or sub DRB) mapping rule for the QoS flow (or sub QoS flow) is different from the QoS flow (or sub QoS flow) to DRB (or sub DRB) mapping of the DL SDAP data PDU and the DRB (or sub DRB) according to the stored QoS flow (or sub QoS flow) to DRB (or sub DRB) mapping rule is configured by RRC with the presence of UL SDAP header:
   i) construct an end-marker control PDU for the QoS flow (or sub QoS flow or QoS flow with the new indicator);
   ii) map the end-marker control PDU to the DRB (or sub DRB) according to the stored QoS flow to DRB mapping rule;
   iii) submit the end-marker control PDU to the lower layers;
d) store the QoS flow (or sub QoS flow) to DRB (or sub DRB) mapping of the DL SDAP data PDU as the QoS flow (or sub QoS flow) to DRB mapping (or sub DRB) rule for the UL.

An embodiment of the present invention provides different data processing for QoE enhancement and dynamic QoS differentiation. The following functions can be performed in the new entity (or layer) or in SDAP entity (or layer) or in PDCP entity (or layer) or in a DRB or in a sub DRB of a DRB).

An embodiment provides a prioritization function for data processing differentiation. The data of a QoS flow with the new indicator (i.e. a sub QoS flow) set to a first value can be prioritized over the data of the same QoS flow with the new indicator set to a second value. The first value indicates higher data rate, lower latency, pre-defined characteristics, or higher priority while the second value indicates lower data rate, higher latency, pre-defined characteristics, or lower priority, and vice versa. e.g. the TCP ACK/NACK packets can be prioritized over the TCP/IP data, e.g. the normal user traffic can be prioritized over the training data of AI/ML.

An embodiment provides a data concatenation function for fast data processing and overhead reduction. The multiple data of a QoS flow with the new indicator set to a first value can be concatenated into one data (e.g. concatenation for multiple data for the same QoS flow or concatenation for multiple data for a QoS flow with the same indicator (i.e. a sub QoS flow)) while the multiple data of the same QoS flow with the new indicator set to a second value are not concatenated. The first value indicates higher data rate, lower latency, pre-defined characteristics, or higher priority while the second value indicates lower data rate, higher latency, pre-defined characteristics, or lower priority, e.g. multiple TCP ACK/NACK packets can be concatenated into one data to increase TCP/IP data rate, e.g. multiple training data of AI/ML can be concatenated into data to reduce the data processing speed.

An embodiment provides a selective security protection function (i.e. ciphering and deciphering or integrity protection and verification) for processing burden reduction. The data of a QoS flow with the new indicator (i.e. a sub QoS flow) set to a first value are security-protected while the data of the same QoS flow with the new indicator set to a second value are not security-protected. The first value indicates higher data rate, lower latency, pre-defined characteristics, or higher priority while the second value indicates lower data rate, higher latency, pre-defined characteristics, or lower priority, and vice versa. e.g. already-security-protected data (in upper layer) or multiple training data of AI/ML may not be security-protected.

An embodiment also deals with Handover. The system information can broadcast the indication about the support of the proposed functionality (i.e. dynamic QoS differentiation or the new indicator in SDAP header or the new indicator of new entity (or layer) (i.e. a sub QoS flow)).

When the network requests UE to report UE capability information by sending UE CapabilityEnquiry message, the UE can send UEcapabilityInformation message including the capability of the proposed functionality.

The source cell can ask about whether the target cell supports the capability of the proposed functionality or not by introducing a parameter in Xn message (or inter-node message). The target cell can respond to this by introducing a parameter in Xn message (or inter-node message), e.g. Yes or No.

If the target cell supports this, the source cell (capable of the proposed functionality) can forward the stored data to the target cell. Otherwise (i.e. if the target cells does not support it), the source cell can forward the stored data to the target cell after removing the new indicator in the new header (or the new header) or the new indicator in SDAP header or the data without the new indicator in the new header (or the new header) or the new indicator in SDAP header.

The target NG-RAN node may also decide to establish a downlink forwarding tunnel for each PDU session. In this case the target NG-RAN node provides information for which QoS flows data forwarding has been accepted and corresponding UP TNL information for data forwarding tunnels to be established between the source NG-RAN node and the target NG-RAN node.

If QoS flows (or a sub QoS flow or a QoS flow with the new indicator) have been remapped at the source NG-RAN node and user packets along the old source mapping are still being processed at handover preparation, and if the source NG-RAN node has not yet received the SDAP end marker for certain QoS flows (or a sub QoS flow or a QoS flow with the new indicator) when providing the SN status to the target NG-RAN node, the source NG-RAN node provides the old side QoS (or a sub QoS flow or a QoS flow with the new indicator) mapping information for UL QoS flows (or a sub QoS flow) to the target NG-RAN node for which no SDAP end marker (i.e. SDAP control PDU) was yet received. The target NG-RAN will receive for those QoS flows (or a sub QoS flow or a QoS flow with the new indicator) the end marker when the UE finalises to send UL user data according to the old source side mapping.

The source NG-RAN node may also propose to establish uplink forwarding tunnels for some PDU sessions in order to transfer SDAP SDUs corresponding to QoS flows (or a sub QoS flow or a QoS flow with the new indicator) for which flow re-mapping happened before the handover and the SDAP end marker has not yet been received, and for which user data was received at the source NG-RAN node via the DRB (or sub DRB) to which the QoS (or a sub QoS flow or a QoS flow with the new indicator) was remapped. If accepted the target NG-RAN node shall provide the corresponding UP TNL information for data forwarding tunnels to be established between the source NG-RAN node and the target NG-RAN node.

As long as data forwarding of DL user data packets takes place, the source NG-RAN node shall forward user data in the same forwarding tunnel, i.e. for any QoS flow (or a QoS flow with a new indicator) accepted for data forwarding by the target NG-RAN node and for which a DRB DL forwarding tunnel was established for a DRB to which this QoS flow (or this sub QoS flow or this QoS flow with the new indicator) was mapped at the source NG-RAN node, any fresh packets of this QoS flow (or this sub QoS flow or this QoS flow with the new indicator) shall be forwarded as PDCP SDUs via the mapped DRB DL forwarding tunnel. If the target NG-RAN does not support the proposed functionality, then, the forwarded PDCP SDU does not include the new indicator in SDAP header or the new header.

For DRBs for which preservation of SN status applies, the source NG-RAN node may forward in order to the target NG-RAN node via the DRB DL forwarding tunnel all downlink PDCP SDUs with their SN corresponding to PDCP PDUs which have not been acknowledged by the UE.

For any QoS flow (or a sub QoS flow or a QoS flow with the new indicator) accepted for data forwarding by the target NG-RAN node for which a DL PDU session forwarding tunnel was established, the source NG-RAN node forwards SDAP SDUs as received on NG-U from the UPF.

As long as data forwarding of UL user data packets takes place for DRBs for which preservation of SN status applies the source NG-RAN node either:
discards the uplink PDCP PDUs received out of sequence if the source NG-RAN node has not accepted the request from the target NG-RAN node for uplink forwarding or if the target NG-RAN node has not requested uplink forwarding for the bearer during the Handover Preparation procedure; or
forwards to the target NG-RAN node via the corresponding DRB UL forwarding tunnel, the uplink PDCP SDUs with their SN corresponding to PDCP PDUs received out of sequence if the source NG-RAN node has accepted the request from the target NG-RAN node for uplink forwarding for the bearer during the Handover Preparation procedure, including PDCP SDUs corresponding to user data of those QoS flows (or a sub QoS flow or a QoS flow with the new indicator), for which re-mapping happened for a QoS flow before the handover and the SDAP end marker has not yet been received at the source NG-RAN node. If the target NG-RAN does not support the proposed functionality, then, the forwarded PDCP SDU does not include the new indicator in SDAP header or the new header.

As long as data forwarding of UL user data packets takes place for a PDU session, the source NG-RAN node forwards via the corresponding PDU session UL forwarding tunnel, the uplink SDAP SDUs corresponding to QoS flows (or a sub QoS flow or a QoS flow with the new indicator) for which flow re-mapping happened before the handover and the SDAP end marker has not yet been received at the source NG-RAN node, and which were received at the source NG-RAN node via the DRB to which the QoS flow (or a sub QoS flow or a QoS flow with the new indicator) was remapped.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as ap-propriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method performed by a user equipment (UE) for Quality of Service (QoS) differentiation for data in a wireless communication system, the method comprising:
receiving a message for radio resource control (RRC) reconfiguration including configuration information associated with a Service Data Adaptation Protocol (SDAP) header, QoS flow mapping, and sub QoS flow;
performing QoS flow mapping to a Data Radio Bearer (DRB) based on a QoS flow ID and a sub QoS flow ID in the configuration information;
transmitting a SDAP data protocol data unit (PDU) with QoS Flow ID (QFI) and a field indicating a sub QoS flow ID to one or more lower layers;
performing integrity protection for the SDAP data including the field, and ciphering for the SDAP data except the SDAP header including the field; and
transmitting the SDAP data after the integrity protection and the ciphering to one or more lower layers.

2. The method of claim 1,
wherein QoS differentiation results in different processing of data are differentiated.

3. The method of claim 1,
wherein the integrity protection and the ciphering is performed at a packet data convergence protocol (PDCP) entity.

4. The method of claim 3,
wherein after integrity protection and ciphering is performed, the resultant data is transmitted to a lower layer for transmission.

5. The method of claim 1,
wherein header compression is not applied to the SDAP header.

6. The method of claim 1,
wherein in case that the QoS flow to DRB mapping is not stored or not configured for the SDAP entity, reflective mapping is applied.

7. A user equipment (UE) for Quality of Service (QoS) differentiation for data in a wireless communication system, the UE comprising:
a transceiver; and
a controller configured to:
receive a message for radio resource control (RRC) reconfiguration including configuration information associated with a Service Data Adaptation Protocol (SDAP) header, QoS flow mapping, and sub QoS flow,
perform QoS flow mapping to a Data Radio Bearer (DRB) based on a QoS flow ID and a sub QoS flow ID in the configuration information,
tranmsit a SDAP data protocol data unit (PDU) with QoS Flow ID (QFI) and a field indicating a sub QoS flow ID to one or more lower layers,
perform integrity protection for the SDAP data including the field, and ciphering for the SDAP data except the SDAP header including the field, and
transmit the SDAP data after the integrity protection and the ciphering to one or more lower layers.

8. The UE of claim 7,
wherein QoS differentiation results in different processing of data are differentiated.

9. The UE of claim 7,
wherein the integrity protection and the ciphering is performed at a packet data convergence protocol (PDCP) entity.

10. The UE of claim 9,
wherein after integrity protection and ciphering is performed, the resultant data is transmitted to a lower layer for transmission.

11. The UE of claim 7,
wherein header compression is not applied to the SDAP header.

12. The UE of claim 7,
wherein in case that the QoS flow to DRB mapping is not stored or not configured for the SDAP entity, reflective mapping is applied.
